(19) United States
(12) Patent Application Publication
(10) Pub. No.: US 2017/0220905 A1
(43) Pub. Date: Aug. 3, 2017

(54) FEATURE GROUPING NORMALIZATION METHOD FOR COGNITIVE STATE RECOGNITION

(71) Applicant: BEIJING UNIVERSITY OF TECHNOLOGY, Beijing (CN)

(72) Inventors: Mi LI, Beijing (CN); Shengfu LU, Beijing (CN); Yu ZHOU, Beijing (CN); Ning ZHONG, Beijing (CN)

(21) Appl. No.: 15/309,784

(22) PCT Filed: Sep. 5, 2014
(86) PCT No.: PCT/CN2014/086010

§ 371 Date: Nov. 8, 2016

(30) Foreign Application Priority Data
May 17, 2014 (CN) 201410209254.4

(51) Int. Cl. G06K 9/62; G06K 9/00; G06K 9/42

(52) U.S. Cl. CPC G06K 9/6269; G06K 9/42; G06K 9/0061

(57) ABSTRACT

A normalization method in grouped feature data for recognizing human cognitive states, comprising: (1) divide feature data into groups; (2) selecting normalization functions and estimating grouping parameters; (3) building grouped normalization functions, substitute normalization function parameters of each group into its normalization function, the normalization mapping relationship of each group is get; (4) grouped normalization processing, each group uses corresponding normalization function to transfer the feature data to finish feature normalization. The entire feature normalization method can only solve the divers data distribution problem between feature and feature, it can not solve the problem of the large difference of inner data distribution, the grouped normalization methods provided in the invention reserve the advantages of entire feature normalization method, while at the same time, the large inner distribution of feature data is reduced, the accuracy of classification is improved, the grouped normalization method in the invention have strong robustness.

### TECHNICAL FIELD

The invention includes a normalization method for pattern recognition, especially includes a normalization method in grouped feature data for recognizing human cognitive states.

### BACKGROUND

Human cognitive states recognition means: through analyzing the external behavior feature to understand internal state of mind, especially for recognition and judgement of human propose and intention in human-computer interaction. The recognition of different human cognitive state by using pattern recognition technology has been a hot spot in research area these years, there are lot of research about recognition method of cognitive states based on magnetic resonance, brain wave and eye movement. The process of cognitive states recognition includes: feature extraction, feature normalization, classifier training and pattern judgement. Feature extraction and normalization have great impact on recognition results. The feature extraction technology used for cognitive states recognition is more complete day by day, but normalization method is not satisfied with cognitive states recognition, so, a normalization method in grouped feature data for recognizing human cognitive states is needed.

The proposal of feature normalization is: every different feature will be transformed into same range domain, the problem of high order level feature occupied large weight when classifier training is avoided, after normalization, the origin feature with small order and big difference play its own role used in judging function. In addition, after normalization for every feature, the change of data range makes classification algorithm astringe better, so that better recognition results are obtained.

Current feature normalization method includes: first, select normalization function which is needed, then, estimate parameters of all data in feature, last, normalization function of feature data which uses same parameters is fully transformed. Since using this kind of normalization method, data with same feature uses normalization function with same feature parameters to do fully transforming, so that it is called fully normalization method of feature.

This fully feature normalization method can solve diverse distribution exist between every feature, researches show that, as for user recognition system based on various biological features and document retrieving system of document relevance generated by different search engine, their recognition performance is improved efficiently by using this method. However, the effect is not ideal for using entire feature normalization method in the process of cognitive states recognition. Although the method unity different range domain of feature, improved cognitive states recognition effect to a certain degree, the problem of diverse distribution exist inner every feature. Using cognitive states recognition feature extraction method usually has these characteristics: first, every feature has diverse distribution, different feature have different distribution position and scale; then, to obtain common difference feature of human cognitive, the invention need to extract large amount of user data, such as cognitive states recognition based on visual behavior, it need to use common difference exist in large amount of user visual feature to distinguish different cognitive states. Obviously, visual feature behavior of different user has difference between each other, such as users' pupil size. So, as extraction results of cognitive states recognition, even it is same feature, the inner distribution is diversity, that is to say, there are individual difference exist between users with same feature.

The diversity problem of inner feature data leads to feature data in different cognitive states overlap with each other, possibility to distinguish it is lower and lower, recognition effect is strongly influenced. While at the same time this problem can not be solved by entire feature normalization method, since there has individual difference between feature data distribution of users, entire feature normalization can only solve the problem of diverse distribution between feature and feature, but inner difference of feature data is preserved, it will generate influence when classifier training which lead to recognition rate can not be improved efficiently.

### CONTENTS OF THE INVENTION

Contents of the invention intend to solve the diverse distribution problem of feature which is extracted during the process of cognitive states recognition, and this problem is not solved by current feature normalization method. The invention discloses a normalization method in grouped feature data for recognizing human cognitive states. The invention can not only solve the problem of diverse distribution problem of feature, but also can solve the problem of big difference inner feature, the accuracy of cognitive states recognition is improved greatly.

The technical schema of the invention is:

A normalization method in grouped feature data for recognizing human cognitivestates, comprising:

(1) divide feature data into groups, feature data X from A category is XAᵢⱼ (i: 1,2,3 . . . , m; j: 1,2, . . . n; m represents user number, n:represents task number of A category),

(1-1) feature data X from B category is XBᵢⱼ (i: 1,2,3 . . . , m; j: 1,2, . . . n; m represents user number, n:represents task number of B category),

(1-2) build feature matrix of X,:X=(XAᵢⱼ, XBᵢⱼ)_{X*(n1+n2)}, is composed:

$$\begin{matrix} ( 1 \text{-} 3 ) & \\ X = [ \begin{matrix}{XA}_{11} & {XA}_{12} & … & {XA}_{1 n 1} & {XB}_{11} & {XB}_{12} & … & {XB}_{1 n 2} \\ {XA}_{21} & {XA}_{22} & … & {XA}_{2 n 1} & {XB}_{21} & {XB}_{22} & … & {XB}_{2 n 2} \\ & & & … … & … … & & & \\ {XA}_{i 1} & {XA}_{i 2} & … & {XA}_{in 1} & {XB}_{i 1} & {XB}_{i 2} & … & {XB}_{in 2} \\ & & & … & … & & & \\ {XA}_{m 1} & {XA}_{m2} & … & {XA}_{mn 1} & {XB}_{m 1} & {XB}_{m 2} & … & {XB}_{mn 2}\end{matrix} ] & formula 1\end{matrix}$$

(1-4) divide feature X into groups based on user, each line of the matrix is a group, “m” users corresponding “m” lines, divided into “m” groups, the No. i group of feature X is:

Xᵢ=(XAᵢ₁ XAᵢ₂ . . . XAᵢₙ₁ XBᵢ₁ XBᵢ₂ . . . XBᵢₙ₂) i=1,2, . . . , m formula 2
(2) Estimae grouping parameters,

(2-1) first, select one normalization function; f (parameter 1, parameter 2, . . . parameter k);

(2-2) according to the parameter request of normalization function, doing parameter estimation for each group of feature X, “m” grouping parameter is get, “k” represents parameter of Xᵢ in i group, these parameters are: (parameter i1, parameter i2, . . . parameter ik), i=1,2, . . . ,
(3) building grouped normalization functions according to (2), building normalization function of each feature X respectively, Xᵢ represents the No. i group (i=1,2, . . . m) normalization function in “m” groups of feature X, normalization parameters of Xᵢ uses corresponding parameters in group i, parameter i1, parameter i2 . . . parameter ik, different grouping have different parameters, so that different normalization function is built by different groups, the “m” groups of feature X build “m” normalization functions, the normalization function of group i can be expressed as: fᵢ (X) i=1,2. . . , m
(4) grouped normalization process

according to grouped normalization functions built by (3), doing the grouped normalization process of feature data of X, No. i group (i=1,2, . . . m) in “m” groups of feature X, Xᵢ uses corresponding normalization function in group ifᵢ (X) to do the grouped normalization process, the approach is: substitute feature data Xᵢ in i group before normalization into normalization function fᵢ (X), feature data Xᵢ ′ after normalization of No. i group is get, as formula 3,

$${X}_{i}^{′} = {X}_{i} \to {f}_{i} ( X ) = ( {XA}_{i 1}^{′} {XA}_{i 2}^{′} … {XA}_{in 1}^{′} {XB}_{i 1}^{′} {XB}_{i 2}^{′} … {XB}_{in 2}^{′} ) \\ {XA}_{ij}^{′} = {XA}_{ij} \to {f}_{i} ( X ) \\ i = 1 , 2 , … , m , j = 1 , 2 , … , n \\ {XB}_{ij}^{′} = {XB}_{ij} \to {f}_{i} ( X ) \\ i = 1 , 2 , … , m , j = 1 , 2 , … , n \qquad formula 3$$

XAᵢⱼ represents feature data of X in A category before grouped normalization,

XBᵢⱼ represents feature data of X in B category before grouped normalization,

XAᵢⱼ′ represents feature data of X in A category after grouped normalization,

XRᵢⱼ′ represents feature data of X in B category after grouped normalization,

after finishing the grouped normalization for each group by using formula 3, the normalization of feature X is finished.

### TECHNICAL SUPERIORITY

The entire feature normalization method can only solve the divers data distribution problem between feature and feature, it can not solve the problem of large difference of inner data distribution, grouped normalization methods provided in the invention reserve the advantages of entire feature normalization method, while at the same time, large inner distribution of feature data is reduced, the accuracy of classification is improved, grouped normalization method in the invention have strong robustness.

### DESCRIPTION OF APPENDED DRAWINGS

FIG. 1: flow chart of normalization method in grouped feature.

FIG. 2: 2 types data distribution comparative figure of normalization method in grouped feature.

FIG. 3: classification effect figure of single feature of normalization method in grouped feature.

FIG. 4: classification effect figure of combined feature of normalization method in grouped feature.

### DESCRIPTION OF THE PREFERRED EMBODIMENTS

The invention will be described in more detail below accompanying the appended drawings with the preferred embodiment.

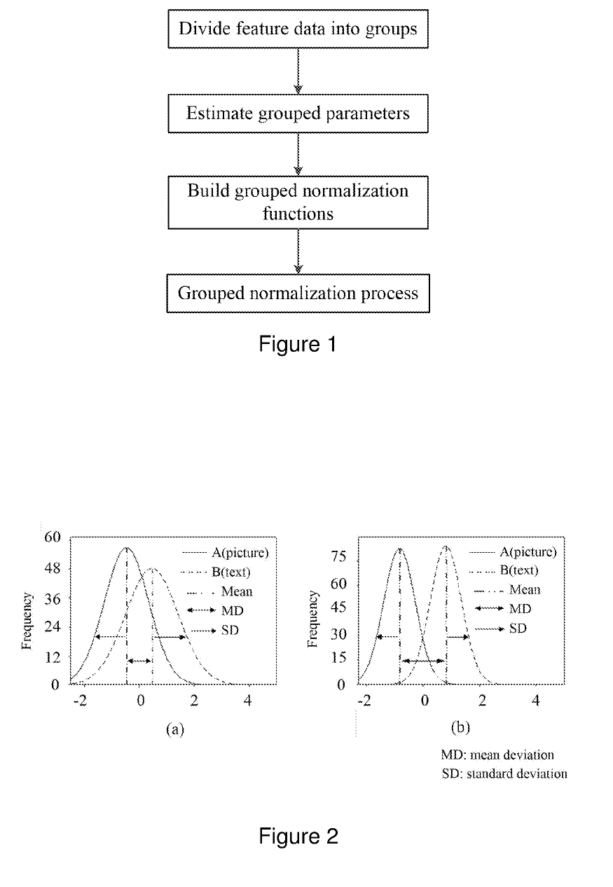

FIG. 1 is the flow chart of normalization method in grouped feature, including 4 parts: feature data grouping, selecting normalization function and parameter estimation, building grouped normalization function, normalization treatment of grouped feature data.

In implanting case, extract visual information during recognition process, 20 tasks of A category (watch images) and 20 tasks of B category (reading text) of 30 users is extracted by Tobii T120 eye movement device (sampling frequency 120 Hz), then, extract four kinds of feature: pupil diameter, saccade amplitude, fixation time and fixation count. After feature extraction, it will move to feature normalization process, takes pupil diameter as an example to introduce the invention in detail.
(1) Feature data grouping of pupil diameter:
(1-1) Calculate pupil diameter data of each A category tasks when 20 tasks of 30 users is carried out, marked as: TAᵢⱼ(i=1,2, . . . 30; j=1,2, . . . 20).
(1-2) Calculate pupil diameter data of each B category tasks when 20 tasks of 30 users is carried out, marked as: TBᵢⱼ(i=1,2, . . . 30; j=1,2, . . . 20).
(1-3) Build feature matrix of pupil diameter feature T, T=(TAᵢⱼ, TBᵢⱼ)_{30*40}, is composed as:

$$T = [ \begin{matrix}{TA}_{11} & {TA}_{12} & … & {TA}_{120} & {TB}_{11} & {TB}_{12} & … & {TB}_{120} \\ {TA}_{21} & {TA}_{22} & … & {TA}_{220} & {TB}_{21} & {TB}_{22} & … & {TB}_{220} \\ & & & … … & … … & & & \\ {TA}_{i 1} & {TA}_{i 2} & … & {TA}_{i 2 \; 0} & {TB}_{i 1} & {TB}_{i 2} & … & {TB}_{i 20} \\ & & & … & … & & & \\ {TA}_{30 \; 1} & {TA}_{302} & … & {TA}_{3020} & {TB}_{30 \; 1} & {TB}_{302} & … & {TB}_{3020}\end{matrix} ] \qquad formula 4$$

The pupil diameter feature T is divided into groups, each line is a group, 30 users corresponding to 30 groups.

According to this method above, group saccade amplitude, fixation time and fixation count respectively.
(2) Select normalization function and parameter estimation
(2-1) Select a normalization function, the invention take Z-score function as feature normalization function, Z-score function has two parameters, mean value Mean (Xᵢ) and standard deviation std (Xᵢ) the formula can be expressed as:

xᵢⱼ′=(xᵢⱼ Mean (Xᵢ))/std (Xᵢ)

xᵢⱼ∈(TAᵢⱼ, TBᵢⱼ)

xᵢⱼ′∈(TAᵢⱼ′, TBᵢⱼ′)

i−1,2, . . . , 30, j=1,2, . . . , 20 formula 5

X′ᵢⱼ represents No. j normalization value of No. i group X′ᵢ after feature data normalization, Xᵢⱼ represents No. j value of No. i group Xᵢ before feature data normalization, Mean(Xᵢ) represents the mean value of Xᵢ in No. i group of feature value, std (Xᵢ) represents the standard deviation of Xᵢ in No. i group.
(2-2) According to the grouping results in (1) and the request of parameters in (2-1), estimate the parameters of each group of pupil diameter feature T, get parameters of 30 groups, can be expressed as:

| (i) | Mean(Xᵢ) | std(Xᵢ) |
|---|---|---|
| 1 | 3.585 | 0.272 |
| 2 | 3.788 | 0.561 |
| 3 | 3.880 | 0.199 |
| 4 | 4.563 | 0.340 |
| 5 | 3.388 | 0.400 |
| 6 | 3.501 | 0.358 |
| 7 | 3.926 | 0.246 |
| 8 | 3.744 | 0.238 |
| 9 | 4.652 | 1.587 |
| 10 | 4.092 | 0.274 |
| 11 | 3.536 | 0.263 |
| 12 | 2.871 | 0.182 |
| 13 | 3.805 | 0.491 |
| 14 | 5.196 | 0.401 |
| 15 | 4.388 | 0.320 |
| 16 | 3.827 | 0.493 |
| 17 | 4.135 | 0.667 |
| 18 | 3.807 | 0.386 |
| 19 | 3.739 | 0.487 |
| 20 | 3.521 | 0.394 |
| 21 | 3.885 | 0.275 |
| 22 | 4.275 | 0.409 |
| 23 | 4.149 | 0.500 |
| 24 | 3.313 | 0.533 |
| 25 | 3.163 | 0.219 |
| 26 | 4.854 | 0.465 |
| 27 | 3.276 | 0.232 |
| 28 | 4.477 | 0.404 |
| 29 | 4.518 | 0.465 |
| 30 | 3.508 | 0.268 |

(3) Building grouped normalization function.
   This case use Z-score function as feature normalization function, building grouped normalization function for each group of pupil feature T, in the 30 groups of feature T, the parameter usage of No. i (i=1,2, . . . 30) group of feature corresponding to the statistic parameters in No. i group, different normalization function of different groups are built, 30 normalization function of 30 pupil diameter feature are built, for example, grouped normalization function of group 1 in formula 4, can be expressed as:

$${x}_{1 j}^{′} = ( {x}_{1 j} - 3.585 ) \text{/} {0.272}_{10} \\ {x}_{1 j} ∈ ( {TA}_{1 j} , {TB}_{1 j} ) \\ {x}_{1 j}^{′} ∈ ( {TA}_{1 j}^{′} , {TB}_{1 j}^{′} ) \\ j = 1 , 2 , … , 20 \qquad formula 6$$

x′ᵢⱼ represents pupil diameter data of group 1 after grouped normalization, X₁ⱼ represents pupil diameter data of group 1 before grouped normalization, 3.585 is mean value of group 1, 0.272 is standard deviation og group 1, TA₁ⱼ, TB₁ⱼ represents pupil diameter feature data of A and B category before normalization respectively,
TA₁ⱼ′, TB₁ⱼ′, represents pupil diameter feature data of A and B category after normalization respectively.
(4) Grouped normalization process
Using grouped normalization function of pupil diameter feature in (3), doing the grouped normalization process of feature data of pupil diameter feature, the normalization process of
No. i group (i=1, 2, . . . , 30) in 30 groups of pupil diameter feature using corresponding No. i normalization function to normalize. After finishing 30 groups normalization of feature data, pupil diameter feature matrix T′ is obtained, as formula 7. Then according to the method above to do the normalization processes of saccade amplitude, fixation time and fixation count.

$${T}^{′} = [ \begin{matrix}{TA}_{11}^{′} & {TA}_{12}^{′} & … & {TA}_{120}^{′} & {TB}_{11}^{′} & {TB}_{12}^{′} & … & {TB}_{120}^{′} \\ {TA}_{21}^{′} & {TA}_{22}^{′} & … & {TA}_{220}^{′} & {TB}_{21}^{′} & {TB}_{22}^{′} & … & {TB}_{220}^{′} \\ & & & … … & … … & & & \\ {TA}_{i 1}^{′} & {TA}_{i 2}^{′} & … & {TA}_{i 20}^{′} & {TB}_{i 1}^{′} & {TB}_{i 2}^{′} & … & {TB}_{i 20}^{′} \\ & & & … & … & & & \\ {TA}_{30 \; 1}^{′} & {TA}_{302}^{′} & … & {TA}_{3020}^{′} & {TB}_{30 \; 1}^{′} & {TB}_{302}^{′} & … & {TB}_{3020}^{′}\end{matrix} ] \qquad formula 7$$

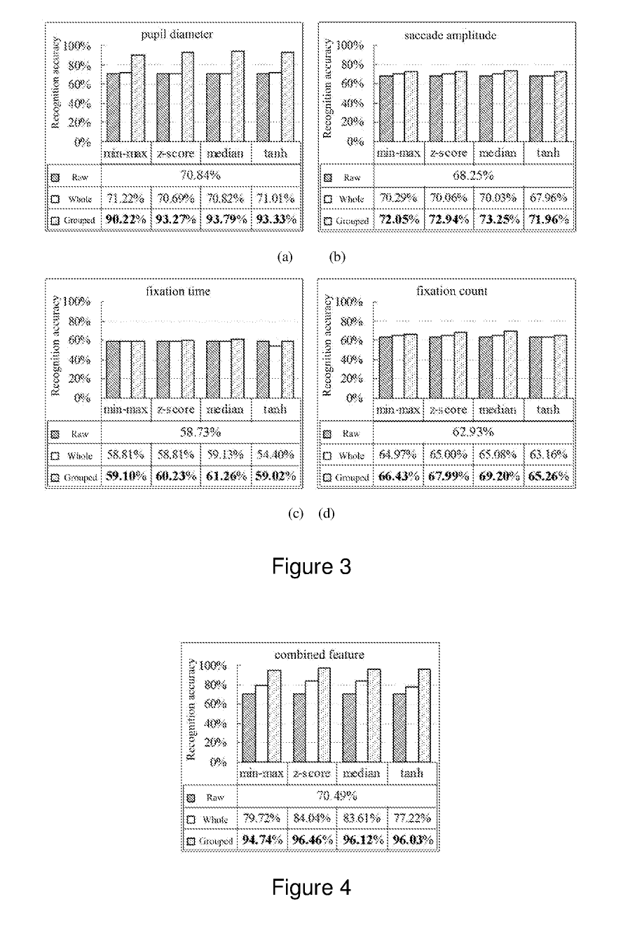

(5) Evaluation of normalization method in the invention
(5-1) FIG. 2 is a comparative result of Log-normal distribution fitting between feature grouped normalization (FIG. 2a) and feature entire normalization (FIG. 2b) which is disclosed in the invention. The result shows, when using feature entire normalization method, the mean difference between A and B feature is 0.92, when using feature grouped normalization method in the invention, the mean difference between A and B feature increases to 1.63, which is 1.77 times as former one. The bigger the mean difference between A and B feature is, the further the distribution distance it has and the smaller the overlapping degree is, so that the better recognition effect is reached. What's more, as for inner category standard deviation, when using feature entire normalization method, the standard deviation of A feature is 0.96, when using feature grouped normalization method in the invention, the standard deviation of A feature decreases to 0.55 which is 0.57 times as the former one, the standard deviation of B feature using feature grouped normalization method is 0.69 times as the former one. No matter A or B feature, when using the method in the invention, their inner category standard deviation are decrease, it indicates that distribution range of inner feature is decrease, at the same time, overlapping degree is decrease between two kinds of feature. Using the invention method, the distribution distance between two kinds of feature is becoming large, and distribution range is decrease of each kinds of feature, in another word, the diversity problem inner feature is solved by using normalization method in the invention, so that the overlapping degree of feature is decreased.
(5-2) FIG. 3 is a comparative result of classification between feature grouped normalization and feature entire normalization which is disclosed in the invention. This case uses 4 kinds of normalization function (Max-Min, Z-score, Median, tanh) corresponding to 4 kinds of feature, pupil diameter (FIG. 3a), saccade amplitude (FIG. 3b), fixation time (FIG. 3c), fixation count (FIG. 3d), to do feature entire normalization and feature grouped normalization disclosed in the invention, after that, using support vector machine based on the recognition accuracy of mode classification of single feature, result shows, no matter which kind of feature or the normalization function is, the recognition accuracy of invention is higher than feature entire normalization.
(5-3) FIG. 4 shows, after using feature grouped normalization in the invention or feature entire normalization for each feature based on different normalization method, combined these features (pupil diameter+saccade amplitude+fixation time+fixation count), and from the recognition accuracy results of mode classification, no matter which kind of function is used, the combined recognition rate of the invention is higher than feature entire normalization method. The classification recognition accuracy data and combined feature recognition accuracy data based on single feature which is disclosed by the invention shows, the feature grouped normalization method in the invention is not only solved diversity distribution problem of inner feature data, but also solve the diversity problem between features, the advantages of entire normalization are reserved. The grouped normalization method in the invention compare with feature entire normalization method has strong robustness.

1. A normalization method in grouped feature data for recognizing human cognitive states, comprising:
(1) divide feature data into groups,
(1-1) feature data X from A category is XAᵢⱼ(i: 1,2,3 . . . , m; j: 1,2, . . . n; m represents user number, n:represents task number of B category),
(1-2) feature data X from B category is XB ᵢⱼ(i: 1,2,3 . . . , m; j: 1,2, . . . n; m represents user number, n:represents task number of B category),
(1-3) build feature matrix of X,:X=(XAᵢⱼ, XBᵢⱼ)_{m*2n}, is composed:
$$X = [ \begin{matrix}{XA}_{11} & {XA}_{12} & … & {XA}_{1 n 1} & {XB}_{11} & {XB}_{12} & … & {XB}_{1 n 2} \\ {XA}_{21} & {XA}_{22} & … & {XA}_{2 n 1} & {XB}_{21} & {XB}_{22} & … & {XB}_{2 n 2} \\ & & & … … & … … & & & \\ {XA}_{i 1} & {XA}_{i 2} & … & {XA}_{in 1} & {XB}_{i 1} & {XB}_{i 2} & … & {XB}_{in 2} \\ & & & … & … & & & \\ {XA}_{m 1} & {XA}_{m2} & … & {XA}_{mn 1} & {XB}_{m 1} & {XB}_{m 2} & … & {XB}_{mn 2}\end{matrix} ] \qquad formula 1$$
(1-4) divide feature X into groups based on user, each line of the matrix is a group, “m” users corresponding “m” lines, divided into “m” groups, the No. i group of feature X is:
Xᵢ=(XAᵢ₁ XAᵢ₂ . . . XAᵢₙ₁ XBᵢ₁ XBᵢ₂ . . . XBᵢₙ₂) i=1,2, . . . , m formula 2
(5) Estimate grouping parameters,
(2-1) first, select one normalization function; f (parameter 1, parameter 2, . . . parameter k);
(2-2) according to the parameter request of normalization function, doing parameter estimation for each group of feature X, “m” grouping parameter is get, “k” represents parameter of Xᵢ in i group, these parameters are: (parameter i1, parameter i2, . . . parameter ik), i=1,2, . . . , m
(6) building grouped normalization functions
according to (2), building normalization function of each feature X respectively, Xᵢ represents the No. i group (i=1,2, . . . m) normalization function in “m” groups of feature X, normalization parameters of Xᵢ uses corresponding parameters in group i, parameter i1, parameter i2. . . parameter ik, different grouping have different parameters, so that different normalization function is built by different groups, the “m” groups of feature X build “m” normalization functions, the normalization function of group i can be expressed as: fᵢ (X)i=1,2, . . . , m
(7) grouped normalization process p2 according to grouped normalization functions built by (3), doing the grouped normalization process of feature data of X, No. i group (i=1,2, . . . m) in “m” groups of feature X, Xᵢ uses corresponding normalization function in group i fᵢ (X) to do the grouped normalization process, the approach is: substitute feature data Xᵢ in i group before normalization into normalization function fᵢ (X), feature data Xᵢ ′ after normalization of No. i group is get, as formula 3,
$${X}_{i}^{′} = {X}_{i} \to {f}_{i} ( X ) = ( {XA}_{i 1}^{′} {XA}_{i 2}^{′} … {XA}_{in 1}^{′} {XB}_{i 1}^{′} {XB}_{i 2}^{′} … {XB}_{in 2}^{′} ) \\ {XA}_{ij}^{′} = {XA}_{ij} \to {f}_{i} ( X ) \\ i = 1 , 2 , … , m , j = 1 , 2 , … , n \\ {XB}_{ij}^{′} = {XB}_{ij} \to {f}_{i} ( X ) \\ i = 1 , 2 , … , m , j = 1 , 2 , … , n \qquad formula 3$$
XAᵢⱼ represents feature data of X in A category before grouped normalization,
XBᵢⱼ represents feature data of X in B category before grouped normalization, XAᵢⱼ′ represents feature data of X in A category after grouped normalization, XBᵢⱼ′ represents feature data of X in B category after grouped normalization,
after finishing the grouped normalization for each group by using formula 3, the normalization of feature X is finished.
